(19) United States
(12) Patent Application Publication
(10) Pub. No.: US 2026/0357407 A1
(43) Pub. Date: Nov. 12, 2026

(54) METHOD AND SYSTEM FOR OPERATING AND/OR DECARBONIZING A MORE PARTICULARLY INDUSTRIAL PRODUCTION PROCESS

(71) Applicant: Fontaine Holdings NV, Houthalen (BE)

(72) Inventors: Thomas PINGER, Houthalen (BE); Lars BAUMGURTEL, Houthalen (BE); Birgitt BENDIEK, Houthalen (BE); Robert MILL, Houthalen (BE)

(21) Appl. No.: 19/470,655

(22) PCT Filed: Mar. 6, 2024
(86) PCT No.: PCT/EP2024/055806

§ 371 Date: Sep. 29, 2025

(30) Foreign Application Priority Data
Mar. 27, 2023 (DE) 102023001171.1
Apr. 18, 2023 (DE) 102023109687.7

(51) Int. Cl. C23C 2/00; C23C 2/06

(52) U.S. Cl. CPC C23C 2/522; C23C 2/0036; C23C 2/06

(57) ABSTRACT

The present invention relates to a method for operating and/or decarbonizing a more particularly industrial production process, preferably a coating process, such as a galvanizing, in which a heated melt is provided and/or kept available, wherein the melt is heated selectively by means of at least one electric heating device and/or at least one non-electric heating device, and wherein if there is excess power in a power grid, at least some of it is taken from the power grid and used to operate the electric heating device.

### CROSS-REFERENCES TO RELATED APPLICATIONS

This application is a National Stage filing of International Application PCT/EP 2024/055806 (WO 2024/199919) filed Mar. 6, 2024, entitled “METHOD AND SYSTEM FOR OPERATING AND/OR DECARBONISING A MORE PARTICULARLY INDUSTRIAL PRODUCTION PROCESS” claiming priority to DE 10 2023 001 171.1 filed Mar. 27, 2023, and DE 10 2023 109 687.7 filed Apr. 18, 2023. The subject application claims priority to DE 10 2023 001 171.1, DE 10 2023 109 687.7 and PCT/EP 2024/055806 and incorporates all by reference herein, in their entirety.

### BACKGROUND OF THE INVENTION

The invention relates to a method and a system for operating and/or decarbonizing a particularly industrial production process, preferably a coating process, such as galvanizing, in which a heated melt is provided and/or stored. In addition, the invention also relates to uses of the system in question in heat-consuming processes, preferably in coating processes, such as galvanizing.

The present invention relates to the field of operating industrial processes in the context of which the production, treatment and/or processing of real goods or products is carried out on a commercial scale. For the purposes of the present invention, an “industrial process” is thus to be understood as mass production and/or mass manufacturing or the commercial processing of real goods or components, in particular for coating workpieces.

Industrial production processes inevitably require a high level of process heat, especially during heat treatment or process steps that are intended to change the material properties and/or characteristics. Due to the industrial scale of the production processes in question, it is in the nature of things that the heat or energy supply required for this must be ensured continuously and/or over the entire production process, and thus permanently.

In this context, the present invention is specifically aimed at heat-consuming production processes which are carried out using a heated melt or in which a heated melt is provided and/or stored. Heated melts are preferably to be understood as liquid metal of any kind and alloy, which is used in industrial production processes in a variety of ways, for example in the casting or coating of workpieces.

However, the primary starting point of the invention is coating processes in which a firmly adhering layer of shapeless material is applied to the surface of a workpiece. For this purpose, a heated melt acting as a coating mass is then held in reserve or provided accordingly.

A coating process used particularly frequently in industry is galvanizing, especially hot-dip galvanizing, whereby a metallic, molten zinc coating is applied to protect against rust or corrosion by immersing the workpieces to be coated in the zinc-containing coating compound.

In galvanizing in particular, it is crucial that the molten zinc provided for the coating is kept at a defined process temperature permanently or with a constant heat supply. This is the only way to ensure targeted process control due to the dependency between the coating quality to be achieved on the one hand and the temperature of the melt or coating mass on the other.

In practice, the process heat required in production processes of the type mentioned above, particularly in coating processes or galvanizing, is covered by burning fossil fuels, usually gas, such as natural gas. In practice, for example, a galvanizing furnace with the coating or galvanizing mass inside is heated using gas burners operated with natural gas.

However, the use of natural gas in industrial processes is problematic due to the associated emissions of climate-damaging substances such as carbon dioxide. In addition to the associated lack of sustainability and climate impact, there are also a number of geopolitical aspects that speak against the use of natural gas as an energy source, especially in industrial processes.

The above disadvantages are particularly significant in the industrial processes in question involving the use of a melt, since the continuous heating or heating of the melt to a comparatively high process temperature requires a particularly high energy input and ultimately high consumption of the fossil fuels or natural gas required for this purpose.

Despite the disadvantages described above, the implementation of natural gas for the generation of process heat in industrial production processes is essentially suitable for the complex process control for the permanent and defined heating of melts, as the combustion of natural gas, which is usually carried out via a large number of gas burners, basically ensures sufficient heat coupling and thus reliable heating of the melt. In this respect, and in view of the high costs associated with any conversions to the plant technology, natural gas fuel has not been used as an energy source in coating processes, particularly in galvanizing.

### BRIEF SUMMARY OF THE INVENTION

It is now the objective of the present invention to avoid or at least substantially reduce the aforementioned disadvantages of the prior art.

In accordance with the invention, a method and a system for operating and/or decarbonizing an industrial production process are proposed for solving the aforementioned objective, wherein the heating of the melt is either carried out by means of at least one electrical heating device and/or at least one non-electrical heating device. This means that the heating can be operated only electrically, only non-electrically or in combination—hybrid—electrically and non-electrically at the same time.

In developing the present invention, it was recognized that there are a number of advantages to no longer heating the melt exclusively using a non-electrical or gas-based energy source but instead using an electrical heating device as an option. The melt can be heated by means of electrical heat storage in addition to the non-electrical heating device or as a complete replacement for the non-electrical or gas-based heating device.

In this respect, the term “optionally” or “either” ultimately encompasses three different process methods or modes for providing the entire power required for the industrial process or for heating the melt. Thus, depending on the process, the melt can be heated exclusively by means of the non-electrical heating device (first process mode). Furthermore, it is possible to couple the heat by means of a combined heat input using the non-electrical heating device and the electrical heating device (second process mode). Finally, it may also be possible to heat the melt exclusively using the electrical heating device (third process mode).

Due to the optional use of the electrical heating device, the disadvantages associated with non-electrical or gas-based heating devices are avoided or mitigated, in particular with regard to the avoidance of climate-damaging emissions such as carbon dioxide. This creates the basis for the decarbonization envisaged in the process, since the replacement of an electrical heating device as provided for in the invention allows the heat required for heating the melt to be coupled with a significant reduction and, in some cases, complete avoidance of climate-damaging emissions such as carbon dioxide emissions.

In this respect, the term “decarbonization”, as used in the context of the present invention, is to be understood as an avoidance or at least reduction of climate-damaging emissions, such as those produced in conventional industrial processes, in particular in the combustion of fossil fuels such as natural gas. The term “climate-damaging emissions” is to be understood broadly and ultimately includes all gaseous emissions that have a negative impact on the climate. The present invention is primarily aimed at avoiding or reducing carbon dioxide (CO₂) but is not limited to this. For example, other gases, such as carbon monoxide, methane, nitrous oxide or other greenhouse gases (GHG) with a negative impact on the climate, can also be climate-damaging emissions within the meaning of the teachings of the invention.

In other words, a hybrid heating concept is proposed in accordance with the invention, whereby an electrical heating device is used optionally or at least proportionally for permanent heating of the melt, accompanied by the desired decarbonization of the industrial process to be operated.

The term “permanent” provision or availability of the melt preferably refers to a period of at least one hour, preferably at least 5 hours, in particular at least 10 hours, whereby, depending on the scope of the process control, this may also include one day or 24 hours up to several days. In this respect, the term “permanent” should preferably be understood in a broad sense.

In particular with reference to a coating process or galvanizing, the term “permanent” defines the operating time during which a melt held in a vessel can be used in a stationary and/or functional manner for coating workpieces as part of a coating process without draining or preparation.

Moreover, the term “melt”, as it is preferably used in the context of the present invention, is to be understood as a preferably non-ferrous metallic coating mass which is provided and/or held in a vessel or other holding means and which is used in a stationary manner or as an immersion bath with at least substantially constant volume or mass over the entire process time, i.e. without draining from the vessel. In this respect, a melt in the sense of the present invention is preferably not to be understood as a foundry melt for casting or primary molding of corresponding foundry products. Nevertheless, the use of the method according to the invention can also be expedient in foundry processes and is thus expressly covered by the teaching according to the invention.

When developing the invention with the hybrid heating strategy described in an industrial process, a number of technical prejudices had to be overcome. Depending on the application or specific requirements, industrial processes have so far used either burners that are heated with natural gas or other fossil gaseous energy sources. Alternatively, heat-consuming processes using only electricity, either inductive or resistance heating, are known. Due to the complex process control involved in heat-consuming processes, hybrid use combining electrical and non-electrical energy sources has not been considered to date. In particular, it has also been considered disadvantageous and disproportionate in other technical fields to provide hybrid systems, as changing energy sources or the associated energy input involves complicated conversion and switching measures and a corresponding interruption of the heat supply. This interruption can last from several minutes to hours, accompanied by corresponding interruptions in production and technical precautions to prevent the process temperature from dropping. As a result, the use of hybrid systems or parallel operation of electrical and non-electrical heating in heat-consuming processes has not been considered in practice to date.

Turning away from this prevailing opinion, it has now been recognized in the context of the solution according to the invention that a hybrid heating system, consisting of an electrical heating device and a non-electrical heating device, is very well suited in industrial production processes, specifically for heating a melt held or provided in particular for a coating process.

Within the context of the invention, it was determined that melts requiring continuous heating, preferably metal melts and/or non-ferrous melts, in particular zinc-containing metal melts, are therefore suitable for hybrid heat supply because they have a comparatively high thermal inertia or their temperature changes relatively slowly during heat supply and/or heat removal due to a relatively high mass and heat capacity. This results in a comparatively large time window or reduced sensitivity for implementing the above-described process modes or the selection of a heating device or the switching from one heating device to another and the hybrid heating system.

As a result, the present invention proposes for the first time and in the form of a self-contained concept that, in order to decarbonize a heat-consuming process, the heating of a melt used in this process should not be implemented exclusively by means of gas-based or non-electrical heating, but at least partially or optionally also by means of an electrical heating device, whereby parallel or simultaneous heating by means of non-electrical and electrical heating devices can also be implemented. simultaneous heating by means of the non-electrical and electrical heating device is also possible.

Due to the inertia of the melt, the optional heating by means of the electrical heating device and/or the non-electrical heating device provided for in the process ensures that, even in the event of a brief interruption of the heat input into the melt to be heated, there is no loss of process performance compared to the non-electrical or gas-based heating known from the prior art.

As a specific supplement to the hybrid heating described above, the invention also provides that, in order to operate the electrical heating device, an excess current occurring in a power grid, in particular in the public power grid, is at least partially extracted and used to operate the electrical heating device.

In this context, surplus electricity is electricity that is only available with fluctuating output over time and can therefore lead to an oversupply of electricity or overcapacity in the power grid. In this respect, situations are increasingly occurring in which electrical energy or electricity cannot be fully consumed due to the oversupply of excess electricity in the power grid.

Surplus electricity, i.e. electrical energy with fluctuating output over time, is due in particular to the share of renewable energies, the electricity share of which is increasingly and prioritized fed into the power grid. As the underlying energy sources, namely sun, wind and water, are not constantly available over time and their availability is also difficult to predict, fluctuating output and overcapacity or periods of surplus electricity are ultimately unavoidable. For example, a short-term high level of wind can lead to an oversupply of electricity or to power peaks in the power grid, accompanied by the problem that the resulting excess electricity must be diverted or consumed in order to avoid overloading the power grid and the associated damage.

The term “power grid”, as used in the context of the present invention, is preferably to be understood broadly and in electrical power engineering refers to a network for the transmission and distribution of electrical energy. It consists of electrical lines such as overhead lines and underground cables as well as the associated equipment such as switching stations and substations. Large, spatially adjacent and electrically connected power grids are referred to as interconnected grids, while small, spatially separated power grids are referred to as isolated grids. The method according to the invention is particularly preferably used in power grids that obtain at least part of their electrical energy from renewable energies.

In the near future, the feed-in of proportionately increasing renewable energies from sun, wind and water into the power grid will therefore increasingly lead to electricity peaks and/or surplus electricity, which can only be purchased incompletely by electricity consumers and is therefore offered on the electricity market as so-called surplus electricity well below its production costs or at prices that are lower in relation to its energy content than for a fossil fuel with the same calorific value, or for free, i.e. without consideration, or even at negative prices.

So far, overload current has not been used to reduce power peaks in connection with metal smelting. Instead, attempts have been made in practice to store excess power or power peaks in storage systems such as batteries and pumped-storage power plants and feed them back into the grid later. However, the use of battery systems is problematic in terms of costs and the associated resource requirements. From an ecological point of view in particular, the use of batteries with a limited service life and decreasing performance in the long term or with increasing use is counterproductive and therefore not expedient from a sustainability perspective. The recycling and disposal of batteries on the required scale is also known to be problematic.

With regard to the buffers and storage systems in question, it should also be noted that the construction of such systems is very costly and, depending on the geographical conditions and the high losses associated with the conversion of energy, is not a viable solution.

In this respect, no satisfactory concept has yet been developed in practice to make targeted use of surplus electricity. At the same time, however, the handling of surplus electricity is an important aspect with regard to the energy transition, as the surplus electricity in question is mainly generated from renewable energies.

The invention now makes it possible to use the electrical energy generated from excess current specifically to operate an electrical heating device or to heat a melt.

This requirement is based on the above-mentioned realization that heating the melt using an electrical heating device on an industrial scale in combination with a non-electrical heating device is at all feasible.

Against this background, the solution according to the invention also contributes to preventing overloading of the power grid and to the efficient use of surplus electricity, which primarily comes from renewable energy sources such as solar, wind and hydro power.

As a result, the solution according to the invention thus provides a specifically coordinated concept, whereby two findings are combined for a specific purpose, which are already advantageous in themselves with regard to decarbonization and/or avoidance of climate-damaging emissions, such as carbon dioxides.

Decarbonization is therefore already achieved through the use of electric heating systems. This basic idea is then completed or supplemented by the additional requirement that surplus electricity is specifically used to operate the electric heating systems. This surplus electricity comes primarily from renewable energy sources, meaning that the surplus electricity itself also comes from an emission-free source. This enables an emission-free process chain to be achieved while completely avoiding the formation of climate-damaging emissions such as carbon oxides.

In this respect, the solution according to the invention contributes to the decarbonization of an industrial production process using a melt, while at the same time providing for the integration of surplus electricity or electricity generated from renewable energies, thereby also addressing aspects of grid serviceability and grid relief.

Based on the above fundamental considerations of the solution according to the invention, advantageous procedural aspects of the present invention are discussed below.

### BRIEF DESCRIPTION OF THE DRAWINGS

FIG. 1 provides a schematic representation of a system according to the invention and the sequence of the method according to the invention and

FIG. 2 provides a perspective view of a melt received in a vessel for the schematic representation of the hybrid heating process in the sense of the method or system according to the invention.

### DETAILED DESCRIPTION OF THE INVENTION

The occurrence of excess current in the power grid can be detected by a detection device. This can preferably be done automatically, in particular by frequency and/or internet control. A detection device is also understood to mean a receiving device for a signal or similar that is emitted manually or automatically by the grid operator and received by the receiving device. After the excess current is detected, the electrical heating device and the non-electrical heating device are controlled by means of a control and/or regulation device. Accordingly, in the method for operating the production process, a distinction is made between a time period before the occurrence of the excess current and a time period after the occurrence of the excess current, wherein, after the occurrence of the excess current, control/regulation of the electrical and non-electrical heating device preferably takes place, wherein the excess current is used to operate the electrical heating device. The excess current is preferably used in such a way that the heated melt is provided and/or maintained in a defined process temperature range, in particular permanently or over the entire production cycle.

The use of surplus electricity to operate the electric heating system and the shutdown of the non-electrical heating system as required is preferably carried out in such a way that the production process is carried out continuously during electric heating. Accordingly, the use of surplus electricity to operate the electric heating system is not associated with any disadvantages compared to conventional non-electrical or gas-based heating, so that the use of hybrid heating using the electric heating system does not lead to any restrictions in the production process during the changeover from one process to the other. gas-based heating, so that the use of hybrid heating using the electrical heating device does not lead to any restrictions in the production process, which continues continuously during the change from one process mode to another.

With regard to a specific process control, it may preferably be provided that when the excess current occurs and/or is detected, the heating power of the non-electrical heating device is reduced and the operation of the electrical heating device is started, preferably whereby the operation of the non-electrical heating device is terminated and the heating of the melt is carried out exclusively by the electrical heating device using excess current.

This type of process is particularly advantageous when surplus electricity is expected to be available over a longer period of time. In this case, the process can be explicitly designed so that the production process is carried out continuously using only electric heating or the surplus electricity for this purpose. The non-electrical heating system can then be permanently deactivated, resulting in maximum decarbonization and/or avoidance of climate-damaging emissions such as carbon oxides, as the use of fossil fuels is completely eliminated. However, it cannot be ruled out that, starting from purely electric heating, the non-electrical heating system may be switched on again. It is also possible to completely shut down the electric heating system or to heat exclusively with the non-electrical heating system. This always happens when it is foreseeable that surplus electricity will no longer be available.

The reduction or shutdown of the non-electrical heating device and/or the start-up or activation of the electrical heating device can take place continuously or discontinuously. Preferably, the shutdown or start-up is automatically adjusted in such a way that the reduction of the non-electrical heating device is compensated for by a corresponding start-up of the electrical heating device and the total thermal energy and/or process temperature introduced into the melt is maintained at least essentially constant over the entire production process. This avoids undesirable fluctuations in the processing temperature of the melt. This is ultimately made possible by controlling/regulating the temperature of the melt, which is measured continuously.

In this context, a transition time can be defined, the start of which is defined with the detection of the excess current and/or with the start of the shutdown of the non-electrical heating device and/or the start of the start-up of the electrical heating device. The end of the transition time is defined by the complete shutdown of the non-electrical heating device and/or the complete start-up of the electrical heating device.

The transition time in question is preferably freely selectable, whereby flexibly adaptable transition times are possible in principle due to the comparatively high heat capacity of the melt. However, these also depend on the overall volume of the melt pool.

A transition time in the range from a few seconds, for example from a maximum of 45 or a maximum of 30 seconds, to several minutes, for example from 5 to 10 minutes, preferably 5 to 30 minutes, can be provided, within which the non-electrical heating device has been completely shut down and the electrical heating device has been completely started up. However, shorter or longer transition times are also possible, particularly depending on the available excess current and the amount of molten bath.

Preferably, the melt can be heated exclusively by the non-electrical heating device before the occurrence and/or detection of the excess current and the electrical heating device can be added to the non-electrical heating device when the excess current occurs and/or is detected. In this respect, it is preferable that the switching on or activation of the electrical heating device is specifically coupled to the occurrence of excess current, whereby at times when there is no excess current in the power grid, heating is provided exclusively by the non-electrical heating device. However, it is understood that it is also possible to operate the electrical heating device without excess current, for example by connecting it directly to any electrical power source, which is preferably fed at least partially, in particular completely, from renewable energy sources.

With regard to the operation of the non-electrical heating device, a preferred method provides for the non-electrical heating device to be operated with a CO₂-free or at least natural gas and/or CO₂-reduced fuel gas, in particular pure hydrogen or a hydrogen-containing fuel gas, for example a fuel gas in the form of a natural gas-hydrogen mixture.

According to this particularly preferred method, decarbonization is achieved not only by using an electrical heating device, but also by modifying the non-electrical heating device, whereby hydrogen is used or mixed in instead of a pure fossil fuel gas or natural gas. The combustion products of hydrogen are primarily water vapor, which is beneficial in terms of avoiding the formation of climate-damaging emissions, such as carbon oxides, which are produced during the combustion of natural gas.

Preferably as long as pure hydrogen is not yet available on a large industrial, economic scale, it is particularly expedient if the hydrogen is mixed with a carrier gas, preferably natural gas, in order to obtain the hydrogen-containing fuel gas. The carrier gas or natural gas in question is preferably at least partly a process gas produced in an industrial process, such as mine gas and/or coke oven gas.

The hydrogen content in the mixed gas, in particular consisting of or containing natural gas and hydrogen, is preferably at least 20%, preferably at least 40%, particularly preferably at least 60%, very particularly preferably at least 80% or 90%.

In particular, a hydrogen-containing fuel gas is used to operate the non-electrical heating devices, wherein the fuel gas contains at least 1 to 100% by volume, preferably 25 to 100% by volume, particularly preferably 50 to 100% by volume, of hydrogen.

Particularly preferably, the non-electrical heating device is operated exclusively and/or 100% with hydrogen, preferably pure and/or green hydrogen.

In particular, so-called green hydrogen is used exclusively to operate the non-electrical heating device and/or as a pure fuel gas or proportionally in a mixed gas, for example with natural gas. Green hydrogen is produced by electrolysis of water, whereby the electricity required for this is in turn obtained from renewable energy sources.

According to the invention, it is thus also possible to operate the non-electrical heating device at least partially from renewable energies, namely hydrogen obtained from renewable energy sources.

The preferred process control described above with regard to the use of hydrogen, preferably green hydrogen, improves the decarbonization of the process according to the invention and further optimizes the sustainability of the process according to the invention, in particular in addition to the hybrid heating by means of electrical heating energy.

The heat coupling into the melt or the heating of the melt can preferably take place at least partially indirectly via a vessel receiving the melt, preferably with a furnace chamber surrounding the vessel being heated by means of the electrical and/or non-electrical heating device. In particular, the furnace chamber is heated by means of the non-electrical heating device and the melt is additionally heated directly by means of an electrical heating device preferably arranged in the melt.

Accordingly, the non-electrical heating device on the one hand and the electrical heating device on the other are preferably spatially separated. Preferably, the non-electrical heating device can be used in the furnace chamber to heat the vessel wall, whereas the electrical heating device can be accommodated in the vessel for direct contact with the melt. In particular, this prevents the electrical heating device from coming into contact with potentially harmful exhaust gases during the non-electrical heating device or the combustion of the fuel gas. However, it is also possible to arrange the non-electrical heating device and the electrical heating device together in the furnace chamber. For this purpose, the preferably rod-shaped electrical heating device can be provided with a protective layer in order to provide protection against the exhaust gases emitted by the non-electrical or gas-based heating device.

The melt is preferably heated in such a way that the melt is kept at a process temperature that is at least 10 °C, preferably at least 20 °C, in particular at least 30 °C, above the melting temperature of the melt.

It is preferable for the melt to be held at a process temperature in the range from 200 °C to 1200 °C, preferably in the range from 350 °C to 470 °C or preferably in the range from 510 °C to 610 °C.

Particularly preferably, the melt can be held at a process temperature in the range from 400 °C to 600 °C, preferably in the range from 415 °C to 470 °C, or preferably in the range from 510 °C to 610 °C, in particular 520 °C to 600 °C. The temperature ranges in question are preferred for galvanizing processes, whereby the increased temperature range of 510 °C to 610 °C or 520 °C to 600 °C is provided for high-temperature galvanizing.

In particular, the melt is provided and/or stored as an immersion bath, especially a galvanizing bath, in a metallic coating process, whereby at least one component to be coated with the melt is immersed in the melt and dipped out of the melt.

It is particularly preferred that the melt or the immersion bath is provided as a metallic molten alloy. Preferably, a molten zinc alloy is provided or used as the melt.

The process according to the invention has proven to be particularly useful for hot-dip galvanizing or hot-dip galvanizing, in particular batch galvanizing, whereby a material or component to be coated, preferably steel or a steel component, is continuously (for example strip and wire) or in pieces (for example components) immersed in a heated kettle with liquid zinc alloy at temperatures of approximately 400 °C to 600 °C, so that the zinc alloy is applied to the material or component. a steel component, is dipped continuously (e.g. strip and wire) or in pieces (e.g. components) at temperatures of around 400 °C to 600 °C in a heated kettle with liquid zinc alloy, so that it forms a resistant alloy layer of iron and zinc on the steel surface or material surface and a very firmly adhering zinc or zinc alloy layer on top.

The method according to the invention enables a continuous production process, in particular a hot-dip galvanizing process, whereby, compared to the heating of the melt known from the prior art solely on the basis of non-electrical or gas-based heating, no losses whatsoever can be determined with regard to the temperature and/or quality of the melt to be held. At the same time, as described in detail above, the process control according to the invention makes it possible to achieve significantly improved sustainability or grid usefulness due to the associated decarbonization.

Following on from this, the process control according to the invention makes it possible to provide and/or hold the melt at the process temperature permanently and/or over a period of at least 1 hour, preferably at least 5 hours, particularly preferably at least 10 hours.

Alternatively, or additionally, the melt is also provided in a mass or dimension customary for hot-dip galvanizing or industrial galvanizing, preferably with a mass of 200 to 800 t (tons), preferably 250 to 750 t, in particular 300 to 700 t, in particular in a vessel intended for the industrial coating process or for industrial galvanizing.

However, it should be noted that the process according to the invention is not limited to galvanizing or coating processes. Ultimately, the teaching according to the invention can be transferred to all coating processes known from the prior art, provided that a heated melt is used or provided as the relevant coating composition.

In the following, according to a further aspect of the present invention, the system according to the invention for operating and/or decarbonizing an industrial process, preferably an industrial production process, is described.

More specifically, the present invention accordingly also relates to a system for operating and/or decarbonizing a preferably industrial production process using a melt, preferably a coating process, such as galvanizing, wherein a vessel is provided for a melt to be received and heated. The system according to the invention has at least one electrical heating device and at least one non-electrical heating device.

According to the invention, the system has at least one control and/or regulating device for selectively heating the melt by means of the electrical heating device and/or the non-electrical heating device, wherein the control and/or regulating device is additionally designed to at least partially extract a surplus current occurring in a power grid and to operate the electrical heating device with the extracted surplus current. In this way, the previously discussed advantages or special features of the present invention can be implemented in accordance with the device.

Accordingly, the system according to the invention is designed or conceptualized in particular for the implementation of the method discussed above. The advantages mentioned above for the method also apply to the system in the same way.

In a further, preferred embodiment of the invention, the control and/or regulating device has a detection device for detecting the occurrence of the excess current and a control and/or regulating device for operating the electrical heating device and the non-electrical heating device after the excess current has been detected. The detection device can also be designed as a receiving device for receiving signals or the like that are sent by the grid operator or third parties when excess current occurs. The control and/or regulating device can comprise the detection device and the control and/or regulating device as a higher-level assembly. It is understood that, in principle, it is also possible to design the detection device and the control and/or regulation device as modules or units that are separate from each other according to the device and are connected to each other by means of signal technology. The control and/or regulating device is then to be understood abstractly or as a non-device-related, superordinate designation of the structural units in question.

In a further, preferred embodiment of the invention, a furnace chamber at least partially surrounding the vessel is provided, preferably wherein the electrical heating device and/or the non-electrical heating device is/are designed to heat the furnace chamber and/or is/are arranged on or in the furnace chamber, in particular wherein the non-electrical heating device is/are arranged on or in the furnace chamber and the electrical heating device is/are designed to come into contact with the melt and/or is/are arranged to directly heat the melt in the interior of the vessel. in particular wherein the non-electrical heating device is arranged on or in the furnace chamber and the electrical heating device for contacting the melt and/or for directly heating the melt is arranged in the interior of the vessel and/or the electrical heating device is arranged on or in the region of the outside or outer wall of the vessel. The physically separate arrangement of the electrical heating device in relation to the non-electrical heating device prevents the electrical heating device from coming into contact with combustion gases emitted by the non-electrical heating device. In this way, the electrical heating device is protected from harmful exhaust gases from the non-electrical heating device, which enables long-term reliable operation of the hybrid heating system.

The present invention also relates, in view of the above features or advantages, to the use of the system according to the invention for reducing and/or avoiding the formation of climate-damaging emissions, such as carbon oxides, in the generation of process heat in the operation of a heat-consuming process, preferably a coating process, such as galvanizing, in particular hot-dip galvanizing.

Accordingly, the present invention also relates to the use of the system according to the invention for extracting excess current when current peaks occur and/or for increasing the usefulness of the grid in a heat-consuming process, preferably a coating process, such as galvanizing, in particular hot-dip galvanizing.

It is understood that it is also possible to use the system according to the invention both to reduce and/or avoid the formation of climate-damaging emissions, such as carbon dioxides, and to extract excess electricity when electricity peaks occur and/or to increase the usefulness of the grid, i.e. a combination of the above aspects of use. As described above, the uses in question relate to coordinated or mutually reinforcing aspects of decarbonization, since it is precisely the operation of the electrical heating device using excess electricity that initially reduces the proportion of non-electrical heating device, whereby the use of excess electricity, which comes primarily or exclusively from renewable energy sources, brings with it a further increase in decarbonization or increased sustainability.

Accordingly, the uses or aspects in question should preferably be understood in their purposeful combination.

Further features, advantages and possible applications of the present invention are apparent from the following description of embodiments with reference to the drawing and the drawing itself. All the features described and/or illustrated form the object of the present invention, either individually or in any combination, irrespective of their summary in the claims or their relationship to one another.

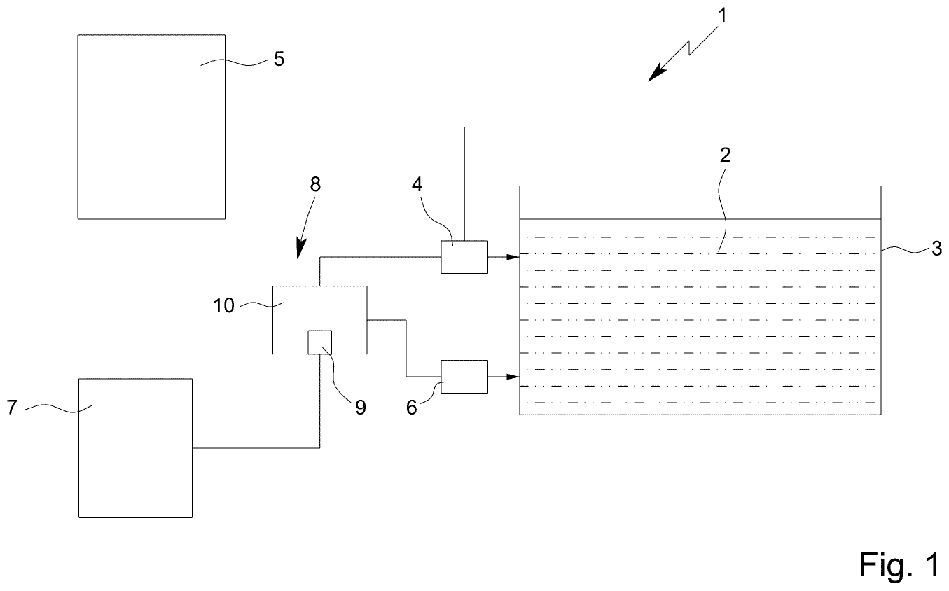

FIG. 1 schematically illustrates a system 1 according to the invention for operating and/or decarbonizing an industrial production process using a melt 2.

In the following, the components or devices of the system 1 according to the invention are first described in order to subsequently discuss the course of the method according to the invention using the system 1 according to the invention on this basis.

In this context, it should be noted that the following explanations with regard to the system 1 according to the invention do not represent the only possibility for implementing the method according to the invention. Rather, a basic concept or a possible implementation is described here in order to practically implement the method according to the invention for operating and/or decarbonizing an industrial production process using a heated melt 2. Based on this, a large number of technical modifications and/or specifications are possible in principle compared to the described system 1 according to the invention.

Since the system 1 according to the invention is designed to operate an industrial production process using the melt 2, the system 1 according to the invention has a vessel 3 in which the melt 2 to be heated can be accommodated or is accommodated.

The melt 2 is preferably designed as an immersion bath, in particular a galvanizing bath, or is used in a metallic coating process, such as galvanizing, in particular hot-dip galvanizing. Accordingly, the heated melt 2 is provided and/or stored as a coating mass.

To heat the melt 2, the system 1 has at least one non-electrical heating device 4, preferably a plurality of non-electrical heating devices 4 is provided. The non-electrical heating device 4 is preferably designed to burn a fuel gas or as a gas burner in order to enable heat to be introduced into the melt 2 to be heated.

Accordingly, the non-electrical heating device 4 is connected to an energy source 5, preferably a gas source. By means of the energy source 5, fuel gas, for example natural gas, in particular natural gas mixed with hydrogen or pure hydrogen, can be made available for operating the non-electrical heating device 4.

If a mixed gas is used, a further, upstream hydrogen source can be provided in order to mix the gas originating from the energy source 5, preferably natural gas, with hydrogen as a further gaseous component or vice versa. The hydrogen is preferably generated from renewable energy sources, which has been produced by electrolysis of water, whereby the water has been broken down into hydrogen and oxygen using renewable electricity. In this respect, it is preferably so-called “green hydrogen”.

For additional or optional heating of the melt 2, the system 1 has at least one electrical heating device 6, preferably a plurality of electrical heating devices 6.

Accordingly, the electrical heating device 6 can be connected to a power grid 7. The power grid 7 is preferably a public power grid. Preferably, the power grid 7 or the electrical energy source contains electricity produced at least in part from renewable energies, which is fed into the power grid 7 as required.

The system 1 according to the invention has a control and/or regulating device 8 for selectively heating the melt 2 by means of the non-electrical heating device 4 and/or the electrical heating device 6.

The control and/or regulating device 8 is designed to extract at least some of the excess current in the power grid 7 and to operate the electrical heating device 6 with the extracted excess current.

For the preferably automatic and/or frequency-or internet-controlled detection of the excess current, the control and/or regulating device 8 has a detection device 9 for detecting the occurrence of the excess current and a control and/or regulating device 10 for operating the electrical heating device 6 and the non-electrical heating device 4 after the excess current has been detected. A detection device 9 is also understood to be such a device which is used to receive signals transmitted by the grid operator or a third party, whereby the transmission of a signal takes place automatically when current peaks or excess current are present in the grid or when such is announced. Signals of this type are automatically generated and transmitted by the grid operator or a third party.

The detection device 9 and the control and/or regulating device 10 are preferably connected to each other by means of signals.

This signaling connection is preferably made in such a way that when the excess current of the detection device 9 occurs and/or is detected, the control and/or regulating device 10 is activated to draw excess current from the power grid 7.

The control and/or regulating device 10 are designed to control or regulate the non-electrical heating device 4 and the electrical heating device 6. For this purpose, the control and/or regulating device 10 is connected to the non-electrical heating device 4 and the electrical heating device 6 by means of signals.

The control and/or regulating device 10 is designed to regulate the heat energy introduced into the melt 2 by the non-electrical heating device 4 and the electrical heating device 6 as a function of the excess current occurring in the power grid 7 and/or the temperature of the melt 2. Preferably, the regulation or control is carried out in such a way that a constant heat input into the melt 2 occurs over the entire occurrence of the excess current and/or a constant defined process temperature of the melt 2 is ensured.

For this purpose, the control and/or regulating device 10 is designed to increase the power of the electrical heating device 6 when the excess current occurs and/or is detected and, preferably simultaneously, to reduce the power of the non-electrical heating device 4, preferably in such a way that the total heat input coupled into the melt 2 by the combination of the non-electrical heating device 4 and the electrical heating device 6 or the associated process temperature remains constant. If the excess flow fluctuates, the control and/or regulating device 10 is also designed to adjust the heat input introduced into the melt 2 by the heating devices 4, 6 accordingly in order to ensure a constant heat input or a constant process temperature even if the excess flow fluctuates.

To control or regulate the heating devices 4, 6, a process temperature in the melt 2 is preferably measured continuously as a controlled variable and compared with a reference variable or the desired process temperature of the melt 2. Based on any control deviation that may occur, the power input of the heating devices 4, 6 is then adjusted by means of the control and/or regulating device 10. In principle, it is also possible to overheat the melt 2 by the electrical heating device 6 in a temperature range of up to 20 °C above the usual process temperature and then to adjust the electric heating for a time until the temperature of the melt 2 drops back to the usual process temperature. The control and/or regulating device 10 is also designed to shut down the non-electrical heating device 4 completely or to cause the melt 2 to be heated exclusively by the electrical heating device 6. The melt 2 is then preferably heated exclusively by means of the electrical heating device 6 or exclusively using excess current.

However, the melt 2 can also be heated by means of the control and/or regulating device 10 with exclusive operation of the non-electrical heating device 4, whereby the control and/or regulating device 10 is accordingly designed to shut down the electrical heating device 6 completely.

It should be noted that the system 1 may also have a further or second (not shown) control and/or regulating device, which may be provided in addition to the control and/or regulating device 8 described or shown. This further or second control and/or regulating device can be provided in particular for the operation of the process if there is no excess current and/or is designed to operate the process or the non-electrical heating device 4 and/or the electrical heating device 6 independently of the power grid 7. Accordingly, the described or first control and/or regulating device 8 is only used when excess current is present or detected in the power grid 7.

Similarly, at least one changeover device can be provided to switch between the non-electrical heating device 4 and the electrical heating device 6. This changeover device is preferably also connected to the control and/or regulating device 8 or the control and/or regulating device 10 by means of signals.

The melt 2 is thus heated optionally by means of the electrical heating device 6 and/or the non-electrical heating device 4.

The term “optional” ultimately defines three different process modes, according to which heating is performed exclusively by the non-electrical heating device 4 (first process mode), by both the non-electrical heating device 4 and the electrical heating device 6 (second process mode) or exclusively by the electrical heating device 4 (third process mode).

To control and/or regulate the heating devices 4, 6 and/or to change the process modes in question, the heating devices 4, 6 are connected to the control and/or regulating device 8 of the system 1 by means of signals.

The heating devices 4, 6 are controlled via the control and/or regulating device 8 in particular in such a way that a defined process temperature or a predetermined temperature interval of the melt 2 is specified as the target or controlled variable. For this purpose, the control and/or regulating device 8 is preferably supplied continuously or at intervals with actual temperatures of the melt 2, on the basis of which the heating devices 4, 6 are then selectively controlled in order to provide the melt 2 continuously at the defined process temperature.

It is understood that the system 1 according to the invention can have temperature sensors or thermocouples, not shown, in the area of the vessel 3 and/or the melt 2 in order to determine the actual temperature of the melt 2.

Due to the combined heating by means of the non-electrical heating device 4 and the electrical heating device 6, decarbonization can take place compared to processes operated only with a non-electrical heating device 4.

With this in mind, the method according to the invention using the system 1 according to the invention is described below.

According to the method, it is envisaged that if excess current occurs in the power grid 7, this is at least partially taken from the power grid 7 and used to operate the electrical heating device 6.

The presence of the excess current is detected, preferably automatically, by the detection device 9, with the result that the regulation or control of the heating devices 4, 6 takes place taking the extracted excess current into account.

Specifically, the control and/or regulating device 10 of the control and/or regulating device 8 is initially designed to operate the electrical heating device 6 using the excess current drawn from the power grid 7.

Simultaneously or alternatively, the control and/or regulating device 10 is also designed to reduce or shut down the heating output of the non-electrical heating device 4 as a result of the excess current occurring and the heating operation taken over by the electrical heating device 6.

The control of the heating devices 4, 6, in particular the start-up of the electrical heating device 6 and the shut-down of the non-electrical heating device 4, continues to take place under the condition that a defined process temperature of the melt 2 is maintained, which continues to be processed as a reference variable or target variable in the control and/or regulating device 8 or the control and/or regulating device 10.

It has proven to be expedient that the melt 2 is initially heated exclusively by the non-electrical heating device 4, which is operated or supplied by the energy source 6, before the excess current is detected. When the excess current from the power supply 7 is detected, the electrical heating device 6 is then switched on, with the result that the heat input previously provided exclusively by the non-electrical heating device 4 is now initially taken over proportionally or completely by the electrical heating device 6.

As a result, the exhaust gas pollution emitted by the non-electrical heating device 4 is reduced, along with the decarbonization of the industrial production process achieved by the process.

At the same time, the use of the surplus electricity is associated with an improvement in grid efficiency in the power grid 7, as the overloading of the power grid 7 that would otherwise occur if the surplus electricity were not used is avoided or compensated for.

Particularly in the case of long-lasting or excessive excess flow, it has proven expedient to completely shut down the heating via the non-electrical heating device 4 and to heat the melt 2 exclusively via the electrical heating device 6.

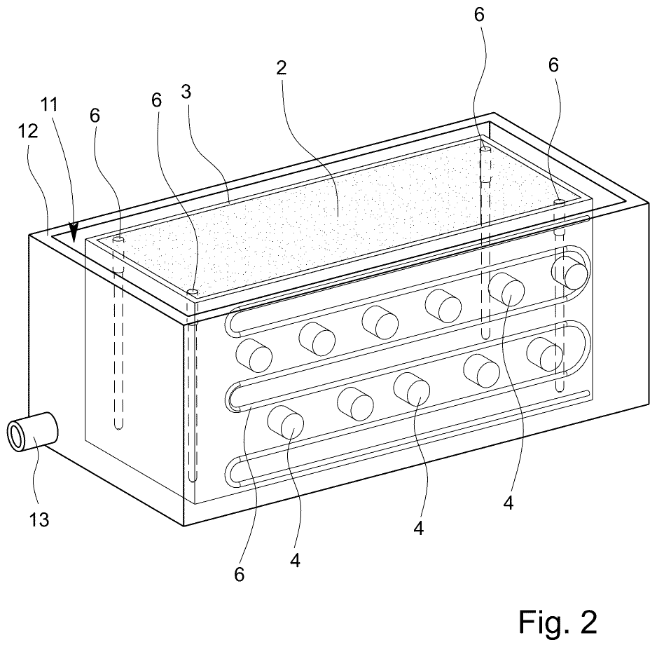

A possible embodiment of arrangements and/or designs of the heating devices 4, 6 for heating the melt 2 held in the vessel 3 is described below with reference to FIG. 2.

In this context, it should be noted that the arrangement shown is a possible technical variant according to the invention for carrying out the method according to the invention, which, however, is not to be understood necessarily or as the only technical possibility. In this respect, the teaching according to the invention is not limited to the arrangement illustrated below and a large number of other embodiments are possible or conceivable.

The connection and/or design of the heating devices 4, 6 for heating the melt 2 is preferably carried out in such a way that the process control can be carried out over the entire process time independently of each other or with exclusive use of the non-electrical heating devices 4 or the electrical heating devices 6, whereby a combined use of the heating devices 4, 6 is also possible with any proportion of the heat coupling introduced by the heating devices 4, 6.

In particular, the electrical heating devices 6 are designed and/or arranged in such a way that the melt 2 can be heated in the range of a defined process temperature exclusively by electrical heating, preferably using only excess current from the power grid 7.

In the embodiment shown in FIG. 2, a furnace chamber 11 at least partially surrounding the vessel 3 is provided, which is preferably designed as an annular chamber and/or surrounds the vessel 3 on all sides.

The furnace chamber 11 is bounded on the inside by the wall of the vessel 3 and on the outside by a furnace housing 12, whereby the vessel 3 is accommodated in the furnace housing 12.

In the illustrated and preferred embodiment example, a plurality of rod-shaped electrical heating devices 6 are provided, which are inserted or immersed in the melt 2 for direct contacting or heating. The electrical heating devices 6 can be arranged inside the melt 2, preferably in pairs on opposite end faces of the vessel 3, in particular in a vertical orientation when in use.

In addition, a plurality of non-electrical heating devices 4 are provided, which are designed as gas burners. The non-electrical heating devices 4 are designed to heat the furnace chamber 11 and/or are arranged on or in the furnace chamber 11, preferably in the region of at least one side wall, in particular longitudinal side wall, of the vessel 3. However, non-electrical heating devices 4 and/or electrical heating devices 6 may also be arranged on opposite side walls, in particular longitudinal side walls, of the vessel 3.

It may be provided that the non-electrical heating devices 4 are arranged and/or accommodated on or in the oven housing 12, preferably in the region of at least one side wall, in particular longitudinal side wall, of the oven housing 12.

In addition to or as an alternative to the electrical heating devices 6 arranged in the melt 2, at least one electrical heating device 6 may also be arranged in the furnace chamber 11. The electrical heating device 6 can preferably be designed as an electrical and/or flexible heating conductor, whereby the length of the electrical conductor exceeds the length of the vessel 3 by a multiple.

The electrical heating device 6 is preferably assigned to the same side wall, in particular the longitudinal side wall, of the vessel 3 as the non-electrical heating devices 4.

In the illustrated and preferred embodiment example, the electrical heating device 6 is arranged in a loop or meander shape around the non-electrical heating devices 4, preferably in such a way that the non-electrical heating devices 4 are surrounded by the electrical heating device 6.

It is understood that other arrangements of the non-electrical heating devices 4 or the electrical heating device 6 can also be provided.

According to an embodiment not shown, it may also be provided that all or at least some of the non-electrical heating devices 4 or heating burners are decoupled from the vessel 3 or furnace chamber 11 and/or arranged in a heating chamber upstream of the vessel 3. This heating chamber then functions as an upstream heating chamber in which already heated heating air or heated heating gas is provided. In contrast, the electrical heating devices 6 are decoupled from the non-electrical heating devices 4 and are directly immersed in the melt 2 and/or arranged in the furnace chamber 11.

Alternatively, or additionally, it can also be provided that all or at least some of the electrical heating device(s) 6 is/are decoupled from the vessel 3 or furnace chamber 11 and/or arranged in a further heating chamber or in the heating chamber upstream of the vessel 3. This one or further heating chamber then functions as an upstream heating chamber in which already heated heating air or heated heating gas is provided. In contrast, the non-electrical heating devices 4 are designed and/or arranged separately from the electrical heating devices 6 for heating the furnace chamber 11.

By storing heated air in the upstream heating chamber, this heated air can be fed into the furnace chamber 11 with a fast response time, provided that, preferably starting from the electric heating of the melt 2, the heating of the melt 2 is switched back to the non-electrical heating device 4. For this purpose, the furnace chamber 11 can be flooded with already heated heating air to ensure that production continues or that the defined process temperature of the melt 2 is maintained. For this purpose, the furnace housing 12 can have a corresponding inlet and/or outlet line 13 to feed a heated heat flow or heated heating air into the furnace chamber 11 as required and/or to discharge used process air from the furnace chamber 11.

The indirect heat coupling by means of the at least one electrical heating device 6 and/or the at least one non-electrical heating device 4 arranged in the furnace chamber 11 takes place in particular in such a way that the air in the furnace chamber 11 is heated via a side wall, in particular a longitudinal side wall, and the wall of the vessel 3 is heated above it. This initially heats the melt 2 on the wall side. Due to the associated heat convection, a flow or circulation of the wall-heated melt 2 into the interior of the vessel 3 takes place, so that heated melt 2, starting from the wall sections, also reaches the interior of the vessel 3 and heated melt 2 is therefore mixed within the vessel 3.

The electrical heating devices 6 are preferably specially insulated or protected from the aggressive exhaust air of the non-electrical heating devices 4, in particular if the heating devices 4, 6 are arranged or accommodated together in the furnace chamber 11.

The inlet and/or outlet 13 can preferably be closed as required and/or provided with a corresponding exhaust gas flap.

In addition, several thermocouples or sensors attached to the vessel 3 are provided in order to preferably continuously monitor and/or record the temperature of the melt 2 and/or the heating temperature in the furnace chamber 11.

The temperature in the vessel 3 and/or in the furnace chamber 11 thus preferably functions as a control variable, which is fed to the control and/or regulating device 8 or the control and/or regulating device 10 for the purpose of regulating the non-electrical heating device 4 and the electrical heating device 6 accordingly. As a result, the heat input of the electrical heating device 6 and/or the non-electrical heating device 4 is regulated or adjusted as required in order to avoid system-critical temperatures and/or to keep the melt 2 at a defined process temperature permanently.

The control and/or regulating device 8 can have a switchover device in order to implement on-demand switching of the heating mode between electrical heating device 4 and non-electrical heating device 6. The changeover device can have corresponding switching and/or line components for this purpose.

The non-electrical heating devices 4 are preferably arranged as a matrix and/or in a fixed group pattern in the furnace chamber 11. Preferably, the non-electrical heating devices 4 are associated with a side wall, in particular a longitudinal side wall, of the vessel 3.

Alternatively or additionally, the non-electrical heating devices 4 and/or the electrical heating devices 6 can be assigned to opposite side walls, in particular longitudinal side walls, of the vessel 3.

For defined heat coupling, the non-electrical heating devices 4 and/or the electrical heating devices 6 can be controlled or regulated individually or in defined zones or groups, in particular by means of the control and/or regulating device 8 and/or the control and/or regulating device 10.

If the control and/or regulating device 8, in particular the detection device 9, receives a pulse from the power grid 7, in particular frequency-or internet-controlled, that there is excess current in the power grid 7, the heat output or firing output of the non-electrical heating devices 4 is reduced by switching off one or more non-electrical heating devices 4 and/or reducing the heat output or firing output of one or more non-electrical heating devices 4. At the same time, the electric heating drive is started via the electrical heating devices 6, using the excess current drawn from the power grid 7.

For this purpose, the non-electrical heating mode can be completely shut down after a defined transition period if necessary, so that no heat is coupled in via the non-electrical heating devices 4. The melt 2 is then preferably heated exclusively via the electrical heating devices 6, which are accommodated in the melt 2. Through convection and mixing in the vessel 3, the entire melt 2 is then heated or heated uniformly by means of the electrical heating devices 6.

The melt 2 can be heated via the electrical heating devices 6 in such a way that the melt 2 is heated above the process temperature or a defined process temperature interval, preferably by at least 20 °C, preferably at least 40 °C above the process temperature. After this overheating, the heating can then be reduced or completely stopped by means of the non-electrical heating devices 4 and/or the electrical heating devices 6 so that the melt 2 cools down again starting from the overheating above the process temperature. If the melt 2 reaches or falls below the process temperature again, the melt 2 can be heated again by means of the non-electrical heating devices 4 and/or the electrical heating devices 6, preferably exclusively by means of the electrical heating devices 6, preferably with the melt 2 being heated again above the process temperature as described above.

In this respect, heating intervals can be defined between which the melt 2 is not heated. Within the heating intervals, the melt 2 is again heated, preferably exclusively by means of the electrical heating device 6.

The duration of the heating intervals can be set flexibly and is preferably carried out in such a way that continuous operation of the coating process is possible both within the heating intervals and between the heating intervals.

### REFERENCE SIGNS

1 System
2 Melt
3 Vessel
4 Non-electrical heating device
5 Energy source
6 Electrical heating device
7 Power grid
8 Control and/or regulating device
9 Detection device
10 Control and/or regulating device
11 Furnace chamber
12 Furnace housing
13 Inlet and/or outlet

1-14. (canceled)

15. A method for operating an industrial production process, wherein the industrial production process comprises a galvanization,
wherein, in said industrial production process, a heated melt comprising a molten zinc alloy is provided and maintained,
wherein the melt is maintained at a defined process temperature range comprising a temperature range of from 200 °C to 1200 °C,
wherein the heating of the melt is effected selectively, upon control, by means of at least one of an electrical heating device and a non-electrical heating device,
wherein, in case of an excess current occurring in an electric power grid, said excess current is at least partially drawn from the electric power grid and is used to operate the electrical heating device,
wherein an occurrence of said excess current is detected by a detection device and wherein the electrical heating device and the non-electrical heating device are operated, upon detection of said excess current, by means of a control and regulating device such that the melt is provided and maintained, using said excess current, within said defined process temperature range.

16. The method according to claim 15,
wherein the industrial production process is operated such that formation of climate-damaging emissions is reduced by using said excess current for providing and maintain the melt within said defined process temperature range.

17. The method according to claim 15,
wherein the method is operated for the purpose of decarbonization of the industrial production process.

18. The method according to claim 15,
wherein the industrial production process is carried out continuously during the operation of the electrical heating device within said defined temperature range.

19. The method according to claim 15,
wherein, upon occurrence of said excess current, the heating power of the non-electrical heating device is reduced and the operation of the electrical heating device is started.

20. The method according to claim 15,
wherein, upon occurrence of said excess current, the heating of the melt by means of the non-electrical heating device is at least partially terminated and the heating of the melt is carried out at least partially by means of the electrical heating device using said excess current.

21. The method according to claim 15,
wherein, upon occurrence of said excess current, the heating of the melt by means of the non-electrical heating device is terminated and the heating of the melt is carried out exclusively by means of the electrical heating device using said excess current.

22. The method according to claim 15,
wherein, before the occurrence of said excess current, the heating of the melt is effected exclusively by the non-electrical heating device and, upon the occurrence of said excess current, the electrical heating device is switched on in addition to the non-electrical heating device.

23. The method according to claim 15,
wherein, before the occurrence of said excess current, the heating of the melt is effected exclusively by the non-electrical heating device and, upon the occurrence of said excess current, the electrical heating device is switched on while the heating of the melt by means of the non-electrical heating device is terminated.

24. The method according to claim 15,
wherein the non-electrical heating device is operated with a fuel gas.

25. The method according to claim 15,
wherein the non-electrical heating device is operated with a fuel gas, wherein the fuel gas is selected from the group consisting of hydrogen, natural gas and hydrogen/natural gas mixtures.

26. The method according to claim 15,
wherein the non-electrical heating device is operated with a fuel gas, wherein the fuel gas is selected from the group consisting of hydrogen, natural gas and hydrogen/natural gas mixtures comprising at least from 1 to 90 vol. % of hydrogen.

27. The method according to claim 15,
wherein the heated melt comprising the molten zinc alloy is contained in a vessel.

28. The method according to claim 15,
wherein the melt is heated at least partially indirectly via a vessel containing the melt.

29. The method according to claim 15,
wherein the melt is heated at least partially indirectly via a vessel containing the melt, wherein a furnace chamber surrounding the vessel is heated by means of at least one of the electrical heating device and the non-electrical heating device.

30. The method according to claim 15,
wherein the melt is heated at least partially indirectly via a vessel containing the melt, wherein a furnace chamber surrounding the vessel is heated at least by means of the non-electrical heating device and wherein the melt is additionally heated by means of the electrical heating device.

31. The method according to claim 15,
wherein the melt is provided and maintained at a process temperature which is at least 10 °C above a melting temperature of the melt.

32. The method according to claim 15,
wherein the melt is maintained at a process temperature in a range selected from the group consisting of a process temperature range of from 350 °C to 470 °C and a process temperature range of from 510 °C to 610 °C.

33. The method according to claim 15,
wherein the industrial production process is carried out as a hot-dip galvanizing process.

34. The method according to claim 15,
wherein the industrial production process is carried out as a hot-dip galvanizing process selected from the group of piece galvanizing and batch galvanizing.

35. A system for operating an industrial production process using a melt comprising a molten zinc alloy, wherein the industrial production process is a galvanizing process,
wherein the system comprises:
a vessel for containing the melt to be heated,
at least one electrical heating device and at least one non-electrical heating device, and
at least one control and regulating device for selectively heating the melt, upon control, by means of at least one of the electrical heating device and the non-electrical heating device,
wherein the control and regulating device is additionally configured so as to at least partially draw an excess current occurring in an electric power grid and to operate the electrical heating device with said drawn excess current, and
wherein the control and regulating device further comprises a detection device for detecting an occurrence of said excess current and an additional control and regulating device for operating the electrical heating device and the non-electrical heating device upon detection of the excess current in such a way that the melt is provided and maintained in a defined process temperature range.

36. The system according to claim 35,
wherein the system further comprises a furnace chamber at least partially surrounding the vessel.

37. The system according to claim 35,
wherein the system further comprises a furnace chamber at least partially surrounding the vessel, wherein the non-electrical heating device is arranged in the furnace chamber and wherein the electrical heating device is arranged at a position selected from the group consisting of the furnace chamber and a position arranged for contacting the melt.

38. The system according to claim 35,
wherein the system is configured for carrying out the method according to claim 15.

39. A method for reducing a formation of climate-damaging emissions when operating a heat-consuming process, wherein the heat-consuming process is a galvanizing process,
wherein the method comprises the step of using a system according to claim 35 for operating the heat-consuming process.

40. A method for drawing an excess current from an electric power grid when current peaks occur in said electric power grid and for increasing the serviceability for an electric power grid when operating a heat-consuming process, wherein the heat-consuming process is galvanizing, wherein the method comprises the step of using a system according to claim 35 for operating the heat-consuming process.
